(19) United States
(12) Patent Application Publication
(10) Pub. No.: US 2024/0116771 A1
(43) Pub. Date: Apr. 11, 2024

(54) MEDIUM-ENTROPY PEROVSKITE OXYGEN CARRIER AND PREPARATION METHOD AND APPLICATION THEREOF

(71) Applicant: TIANJIN UNIVERSITY, Tianjin (CN)

(72) Inventors: Jinlong Gong, Tianjin (CN); Xianhua Zhang, Tianjin (CN); Chunlei Pei, Tianjin (CN); Zhi-Jian Zhao, Tianjin (CN); Xian Yao, Tianjin (CN); Yifan Liu, Tianjin (CN)

(21) Appl. No.: 18/202,730

(22) Filed: May 26, 2023

(30) Foreign Application Priority Data
Oct. 8, 2022 (CN) 2022112199792

(51) Int. Cl. C01F 17/34

(52) U.S. Cl. CPC C01F 17/34; C01P 2002/34

(57) ABSTRACT

The present disclosure relates to the technical field of oxygen carrier, discloses a medium-entropy perovskite oxygen carrier and its preparation method and application thereof, the synthesis procedure includes preparing an aqueous solution from metallic nitrate serving as a raw material, performing a coprecipitation reaction with at least one of aqueous ammonia solution, a sodium hydroxide aqueous solution or a sodium carbonate aqueous solution as a precipitant at a pH value of 9.5 to 10.5; obtaining the La₃CoMnAlO₉ powers after stirring, standing, washing, drying and calcining. The preparation method is simple, synthetic conditions are easy to control, and batch production could be achieved.

### CROSS-REFERENCE TO RELATED APPLICATION

This application claims priority from the Chinese patent application 2022112199792 filed Oct. 8, 2022, the content of which is incorporated herein in the entirety by reference.

### TECHNICAL FIELD

The present disclosure belongs to the technical field of chemical-looping oxygen carriers, and particularly relates to a perovskite oxygen carrier for hydrogen production by chemical-looping reforming of methane and a preparation method thereof.

### BACKGROUND ART

In order to solve increasingly serious environmental problems, countries around the world have reached a consensus of developing low-carbon economies and developing renewable energy. In recent years, despite the rapid development of therenewable energy, the renewable energy still hardly replaces fossil energy as main energy resource in a short term. Hydrogen is an attractive energy carrier due to its high energy density (143 MJ/kg), clean, free of pollution (combustion products are water), and can be used for transportation stationary power generation and ammonia synthesis for energy storage. Thus, it is of great significance for developing a novel economic and pollution-free technology for hydrogen production economic, and studies on hydrogen production in many countries are also correspondingly increasing rapidly. Existing hydrogen production technologies may be divided into hydrogen production from fossil fuel and hydrogen production from renewable resources, in which hydrogen production from fossil fuel is currently the main hydrogen production manner. Hydrogen production from fossil fuel includes natural gas steam reforming, partial oxidation, auto thermal reforming, plasma reforming, aqueous-phase reforming, high-temperature deposition and other methods. Methane steam reforming (reaction 4) is the most widely used hydrogen production technology in the industry at present. However, the main reaction is a strong endothermic process (reaction 1), which is high in energy consumption. Heat is supplied by combusting natural gas outside pipes (reaction 3), and generated CO₂ and air are mixed, leading to high CO₂ capture costs. In addition, such a process has many product purifications (reaction 2) and separation operation units, resulting in high energy consumption and low product separation integration level.

Steam reforming: CH₄+H₂O=CO+3H₂, ΔH(T=800° C.)=225 kJ (1)

Water-gas shift: CO+H₂O=H₂+CO₂, ΔH(T=800° C.)=−34 kJ (2)

Combustion heat supply: CH₄+O₂=CO₂+2H₂O, ΔH(T=800° C.)=−802 kJ (3)

Overall reaction: xCH₄+yH₂O+(x−0.5y)O₂→(2x+y)H₂+xCO₂, ΔH(T=800° C.)=0 kJ (4)

In order to solve the above problems, improve energy conversion efficiency and reduce production costs, researchers are constantly researching and developing novel thermal-chemical hydrogen production processes. Reaction paths are designed again based on a chemical-looping concept, the overall reaction is decomposed into two or more sub-reactions performed in different spaces or time, substances and energy are transferred in a system by cyclically utilizing oxidation and reduction processes of a solid oxygen carrier (usually metal oxide), separate conversion of raw materials and in-situ separation of products are achieved, and therefore the problems of heat supply, separation and carbon capture are integrally solved. Due to inherent advantages of system simplification and/or carbon capture, hydrogen can be produced from the system at high process efficiency, and carbon dioxide can be captured. Thus, the technology for hydrogen production by chemical-looping reforming of methane has attracted extensive attention and research.

The technology for hydrogen production by chemical-looping reforming of methane couples the preparation of syngas by partial oxidation of methane by lattice oxygen and hydrogen production by thermal pyrolysis of water. As shown in FIG. 1, in such process, at a methane reduction stage, an oxygen carrier (MeOₙ) is reduced into low-valence-state oxide MeOₚ or elementary Me, methane is completely oxidized to generate H₂O and CO₂, steam can be directly used for CO₂ capture and storage after being condensed, or the methane is partially oxidized to generate syngas (H₂+CO); and at a steam oxidation stage, MeOₚ or metallic Me is partially oxidized into MeOₘ by the steam, H₂ may be obtained, and lattice oxygen of the oxygen carrier is partially regenerated; and at an air combustion stage, the oxygen carrier is further oxidized by O₂, complete regeneration of the lattice oxygen and removal of residual carbon deposits are achieved, and therefore the oxygen carrier restores to a state (MeOₙ) before reacting with the methane.

As a medium for oxygen atoms and heat transfer, the oxygen carrier circulates between different reactors, which is a key to the whole process of hydrogen production by chemical-looping reforming of methane. Selecting the oxygen carrier is very important in hydrogen production by chemical-looping reforming of methane, and the oxygen carrier needs to have high oxygen storage capacity, sufficient oxygen migration capacity and high reaction activity. In alternate oxidation and reduction reactions, perovskite materials have good structural reversibility and stable reaction properties, which are excellent oxygen carrier materials. Wherein, an ABO₃ perovskite oxygen carrier is one of the most widely studied oxygen carrier materials as it has good electron and oxygen ion migration properties, and sites A and sites B can be replaced with multiple cations. When radii of doping ions at the sites A and the sites B meet a certain condition, AA′BB′O₆ double perovskite can be formed. Compared with ABO₃ perovskite, the AA′BB′O₆ double perovskite usually has higher oxygen vacancy concentration due to two B-site transition metal ions with different valence alternation capacities in a structure. Thus, the double perovskite shows higher electron and oxygen ion migration capacity than that of the ABO₃ perovskite, which is widely studied in fields such as oxygen ion permeable membranes, fuel cells and electrocatalysis, and has also been used for a chemical-looping field in recent years (CN102441396A and CN102441396B). However, a double perovskite oxygen carrier has problems such as unsatisfied syngas selectivity in methane reduction step and low hydrogen yield in steam re-oxidation step caused by too high activity of lattice oxygen, or carbon deposition at a methane reduction stage and low hydrogen purity at a steam re-oxidation stage caused by too low activity of the lattice oxygen. Thus, an ion doping manner is usually used for further adjusting and controlling properties of the lattice oxygen of the double perovskite oxygen carrier, so as to improve the syngas selectivity and the hydrogen yield. However, a crystalline phase structure of the perovskite is easily damaged when the concentration of the doping ions is high, affecting cycling stability of the oxygen carrier. An A₃B′B″B′″O₉ medium-entropy perovskite oxygen carrier is established by selecting proper doping ions, and an entropy of the structure is increased to improve chaos of atoms in the structure, thereby reducing enthalpy of formation of the oxygen carrier and improving cycling stability of the structure of the oxygen carrier. However, pure perovskite phases are hardly prepared as the medium-entropy perovskite oxygen carrier contains four or more metal ions at the same time. Preparation of the perovskite oxygen carrier mainly includes a coprecipitation method, a high-temperature solid-phase reaction method, a sol-gel method, a wet chemistry method and other methods. Application and popularization of the oxygen carrier are limited as the existing preparation methods have the defect that pure-phase perovskite cannot be prepared, or that the preparation methods are complex, high in preparation cost and not beneficial to scaled-up production.

### SUMMARY

The present disclosure provides a medium-entropy perovskite oxygen carrier and a preparation method and application thereof to solve the technical problems that an ABO₃ perovskite oxygen carrier has low methane reaction activity or low syngas selectivity, which is common in an existing partial chemical-looping methane partial oxidation reaction, leading to nonideal syngas yield and nonideal cycling stability of a structure of an AA′BB′O₆ double perovskite oxygen carrier, and that a preparation method of A₃B′B″B′″O₉ medium-entropy perovskite is complex, which is not conducive to scale-up preparation or hardly prepares pure-phase perovskite. In the present disclosure, an aqueous solution is prepared from metallic nitrate serving as a raw material by a simple coprecipitation method; a coprecipitation reaction is performed with aqueous ammonia solution, a sodium hydroxide aqueous solution or a sodium carbonate aqueous solution as a precipitant by adjusting a pH value of the solution, to obtain a hydroxide precursor; and a La₃CoMnAlO₉ medium-entropy perovskite oxygen carrier is obtained after stirring, standing, washing, drying and calcining. The oxygen carrier is used for a system of hydrogen production by chemical-looping reforming of methane in a fluidized bed, so that methane is efficiently converted at a methane reduction stage and hydrogen at high purity is prepared at a steam re-oxidation stage.

To solve the above technical problems, the present disclosure is achieved by the following technical solutions:

According to one aspect of the present disclosure, a preparation method of a medium-entropy perovskite oxygen carrier is provided, including the following steps:
(1) preparing an aqueous solution from metallic nitrate serving as a raw material, and performing a coprecipitation reaction with at least one of aqueous ammonia solution, a sodium hydroxide aqueous solution or a sodium carbonate aqueous solution as a precipitant at a pH value of 9.5 to 10.5, to obtain a hydroxide precursor; and
(2) obtaining a La₃CoMnAlO₉ medium-entropy perovskite oxygen carrier after stirring, standing, washing, drying and calcining.

Furthermore, the metallic nitrate is La(NO₃)₃·6H₂O, Co(NO₃)₃·6H₂O, a Mn(NO₃)₂ aqueous solution and Al(NO₃)₃·9H₂O. An ionic molar ratio of La to Co to Mn to Al is 3:1:1:1.

Furthermore, a mixing manner of the precipitant and the metallic nitrate solution is one of forward dropwise adding, cocurrent or reverse dropwise adding.

According to another aspect of the present disclosure, a medium-entropy perovskite oxygen carrier for hydrogen production by chemical-looping reforming of methane is provided, which is prepared by the above preparation method.

According to yet another aspect of the present disclosure, application of the above medium-entropy perovskite oxygen carrier in a reaction of chemical-looping reforming of methane to hydrogen in a fluidized bed is provided. At a reduction stage, the oxygen carrier reacts with the methane under an oxygen-free condition, the methane is partially oxidized by lattice oxygen in the oxygen carrier to generate syngas, and meanwhile the oxygen carrier is reduced. At an oxidation stage, the oxygen carrier reacts with steam, to obtain part of the lattice oxygen, and meanwhile hydrogen is generated. At an air combustion stage, the oxygen carrier is further oxidized by air to be cyclically regenerated, so that the oxygen carrier restores to a structure before reacting with the methane.

Furthermore, reaction temperatures of the reduction stage and the oxidation stage are 700° C. to 1100° C.

Furthermore, mixed gas of methane and nitrogen is introduced at the reduction stage, wherein a volume percentage of the methane is 5% to 100%, and with benchmarking against methane, a volume space velocity of the reaction is controlled to be 120 h⁻¹ to 12000 h⁻¹.

Furthermore, mixed gas of steam and nitrogen is firstly introduced at the oxidation stage, wherein a volume percentage of the steam is 5% to 100%, and with benchmarking against steam, a volume space velocity of the reaction is controlled to be 120 h⁻¹ to 12000 h⁻¹.

The present disclosure has the following beneficial effects:
1. The oxygen carrier is prepared in the present disclosure by the coprecipitation method, the operation method is simple, synthetic conditions are easy to control, and batch production can be achieved.
2. The La₃CoMnAlO₉ medium-entropy perovskite oxygen carrier prepared in the present disclosure has good structural cycling stability, and has a stable structure after being subjected to several oxidation-reduction regeneration cycle tests, which is still a pure medium-entropy perovskite crystalline phase without phase separation.
3. The La₃CoMnAlO₉ medium-entropy perovskite oxygen carrier prepared in the present disclosure has high methane activity and good carbon deposition resistance in the reaction of chemical-looping reforming of methane to hydrogen in the fluidized bed, so as to obtain high hydrogen purity and hydrogen yield.

### DESCRIPTION OF THE DRAWINGS

FIG. 1 is a schematic diagram of a reaction system of chemical-looping reforming of methane to hydrogen;

FIG. 2 is an X-ray powder diffraction (XRD) diagram of La₃CoMnAlO₉ samples prepared by adopting different precipitants;

FIG. 3 is an XRD diagram of La₃CoMnAlO₉ samples prepared by adopting two precipitants at the same time;

FIG. 4 is an XRD diagram of La₃CoMnAlO₉ samples prepared by adopting different adding manners of a precipitant;

FIG. 5 is an XRD diagram of La₃CoMnAlO₉ samples prepared at different pH values;

FIG. 6 shows results of reaction performance of La₃CoMnAlO₉ medium-entropy perovskite at a methane reduction stage of chemical-looping reforming of methane to hydrogen in a fluidized bed.

FIG. 7 shows results of reaction performance of La₃CoMnAlO₉ medium-entropy perovskite at a steam oxidation regeneration stage in a reaction of chemical-looping reforming of methane to hydrogen in a fluidized bed;

FIG. 8 is an XRD diagram of La₃CoMnAlO₉ samples after 50 cycles of a reaction.

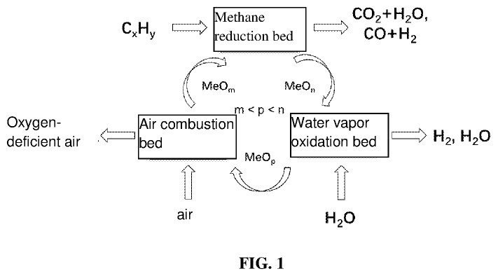

### DETAILED DESCRIPTION OF THE EMBODIMENTS

The present disclosure is further described in detail below through specific embodiments, and the following embodiments can allow those skilled in the art to understand the present disclosure more comprehensively, instead of limiting it in any manner.

### Embodiment 1

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, aqueous ammonia solution was dropwise added into the nitrate solution with stirring by a forward dropwise adding method, to obtain a hydroxide precursor, an addition amount of the aqueous ammonia solution was adjusted, and a final pH value of a mixed solution was controlled at 10; stirring continued for 0.5 hour; and then standing at room temperature was performed for 2 hours;

step 3, the obtained mixed solution was filtered and washed, and dried at constant temperature of 80° C. for 12 hours; and precursor powder was roasted in an air atmosphere at 1300° C. for 4 hours, to obtain a medium-entropy perovskite oxygen carrier, wherein a molecular formula of the oxygen carrier was La₃CoMnAlO₉;

step 4, La₃CoMnAlO₉ solid powder was sieved, and a granular oxygen carrier of 200 meshes to 140 meshes was taken.

### Embodiment 2

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a 2 mol/L sodium hydroxide aqueous solution was dropwise added into the nitrate solution with stirring by a forward dropwise adding method, to obtain a sodium hydroxide precursor, an addition amount of the sodium hydroxide aqueous solution was adjusted, and a final pH value of a mixed solution was controlled at 10; stirring continued for 0.5 hour; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 3

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionised water, to obtain a nitrate solution;

step 2, a 2 mol/L sodium carbonate aqueous solution was dropwise added into the nitrate solution with stirring by a forward dropwise adding method to obtain a hydroxide precursor, an additional amount of the sodium carbonate aqueous solution was adjusted, and a final pH value of a mixed solution was controlled at 10; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 4

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a mixed solution (a 2 mol/L NaOH aqueous solution and aqueous ammonia solution were mixed at an equal volume) of the sodium hydroxide aqueous solution and the aqueous ammonia solution was dropwise added into the nitrate solution with stirring by a forward dropwise adding method, to obtain a hydroxide precursor, an additional amount of the sodium hydroxide aqueous solution was adjusted, and a final pH value of a mixed solution was controlled at 10; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 5

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a 2 mol/L mixed solution (wherein concentrations of sodium hydroxide and sodium carbonate were 1 mol/L respectively) of the sodium hydroxide and the sodium carbonate was dropwise added into the nitrate solution with stirring by a forward dropwise adding method to obtain a hydroxide precursor, an additional amount of the sodium hydroxide aqueous solution was adjusted, and a final pH value of a mixed solution was controlled at 10; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 6

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a mixed solution (a 2 mol/L sodium carbonate aqueous solution and aqueous ammonia solution were mixed at an equal volume) of the sodium carbonate aqueous solution and the aqueous ammonia solution was dropwise added into the nitrate solution with stirring by a forward dropwise adding method, to obtain a hydroxide precursor, an additional amount of the sodium hydroxide aqueous solution was adjusted, and a final pH value of a mixed solution was controlled at 10; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 7

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;
Step 2, a 2 mol/L mixed solution (wherein concentrations of sodium hydroxide and sodium carbonate were 1 mol/L respectively) of the sodium hydroxide and the sodium carbonate and the nitrate solution was slowly dropwise added into another empty container at the same time with stirring by a concurrent coprecipitation method, to obtain a hydroxide precursor, a pH value of a mixed solution was controlled at 9.5 to 10.5 in the period. Finally, an additional amount of the mixed solution of the sodium hydroxide and the sodium carbonate was adjusted, and a final pH value of the mixed solution was controlled at 10; stirring continued for 0.5 hours, and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 8

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, the nitrate solution was slowly dropwise added into 80 mL of a 2 mol/L mixed solution (wherein concentrations of sodium hydroxide and sodium carbonate were 1 mol/L respectively) of the sodium hydroxide and the sodium carbonate with stirring by a reverse dropwise adding method, to obtain a hydroxide precursor, finally, an additional amount of the mixed solution of the sodium hydroxide and the sodium carbonate was adjusted, and a final pH value of a mixed solution was controlled at 10; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 9

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a 2 mol/L mixed solution (wherein concentrations of sodium hydroxide and sodium carbonate were 1 mol/L respectively) of the sodium hydroxide and the sodium carbonate was dropwise added into the nitrate solution with stirring by a forward dropwise adding method to obtain a hydroxide precursor, an additional amount of the sodium hydroxide aqueous solution was adjusted, and a final pH value of a mixed solution was controlled at 9.5; stirring continued for 0.5 hours; and then standing at room temperature was performed for 2 hours;

step 3, the obtained mixed solution was filtered and washed, and dried at a constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 10

Step 1, 12.9900 parts by mass of La(NO₃)₃·6H₂O, 2.9105 parts by mass of Co(NO₃)₃·6H₂O, 3.5790 parts by mass of an Mn(NO₃)₂ aqueous solution (mass fraction is 50%) and 3.7513 parts by mass of Al(NO₃)₃·9H₂O were weighed and dissolved in deionized water, to obtain a nitrate solution;

step 2, a 2 mol/L mixed solution (wherein concentrations of sodium hydroxide and sodium carbonate were 1 mol/L respectively) of the sodium hydroxide and the sodium carbonate was dropwise added into the nitrate solution with stirring by a forward dropwise adding method to obtain a hydroxide precursor, an additional amount of the sodium hydroxide aqueous solution was adjusted, and a final pH value of a mixed solution was controlled at 10.5; stirring continued for 0.5 hours; and then standing at room temperature was performed for 2 hours;

step 3, the obtained mixed solution was filtered and washed, and dried at constant temperature of 80° C. for 12 hours; and precursor powder was roasted in an air atmosphere at 1300° C. for 4 hours to obtain a medium-entropy perovskite oxygen carrier, wherein a molecular formula of the oxygen carrier was La₃CoMnAlO₉; and

step 4, La₃CoMnAlO₉ solid powder was sieved, and a granular oxygen carrier of 200 to 140 meshes was taken.

### Embodiment 11

10.5 mL of the La₃CoMnAlO₉ medium-entropy perovskite oxygen carrier prepared in Embodiment 5 was weighed and added to a monotube micro fluidized bed reactor with an internal diameter of a reaction tube of 20 mm. An experiment was performed at 700° C. and constant pressure. After temperature rose to 700° C. in an N₂ atmosphere, (1) mixed gas (120 mL/min 20% CH₄/He-300 mL/min N₂) of methane and nitrogen with total flow of 400 m/min was introduced for 10 minutes, a volume of the methane was 5% of a total volume of the mixed gas, tail gas within 20 minutes (methane stage for 10 minutes+nitrogen purging for 20 minutes) was collected by a gas bag, and an average composition of the tail gas was analyzed; (2) nitrogen at 300 mL/min continued to be used for purging for 5 minutes; (3) mixed gas (21 mL/min H₂O_{(g)}-399 mL/min N₂) of steam and nitrogen with total flow of 420 mL/min was introduced for 15 minutes, a volume of the steam was 5% of the total volume of the gas, tail gas within 25 minutes (steam stage for 15 minutes+nitrogen purging for 10 minutes) was collected by a gas bag, and a composition of the tail gas was analyzed by gas chromatography; (4) nitrogen at 399 mL/min continued to be used for purging for 5 minutes; (5) air at 420 mL/min was used for oxidation for 10 minutes; and (6) nitrogen at 300 mL/min was used for continuous purging for 15 minutes. Reaction activities of the oxygen carriers in the above embodiment are all an average activity of a corresponding reaction stage; a volume space velocity of the reaction is 120 h⁻¹ with benchmarking against a reactant, namely the methane, and the volume space velocity of the response is 120 h⁻¹ with benchmarking against the steam.

### Embodiment 12

2.4 mL of the La₃CoMnAlO₉ medium-entropy perovskite oxygen carrier prepared in Embodiment 5 was weighed and added to a monotube micro fluidized bed reactor with an internal diameter of a reaction tube of 20 mm. An experiment was performed at 850° C. and constant pressure. After temperature rose to 850° C. in an N₂ atmosphere, (1) mixed gas (180 mL/min 20% CH₄/Ar-180 mL/min N₂) of methane and nitrogen with total flow of 360 m/min was introduced for 5 minutes, a volume of the methane was 10% of a total volume of the mixed gas, tail gas within 15 minutes (methane stage for 5 minutes+nitrogen purging for 10 minutes) was collected by a gas bag, and an average composition of the tail gas was analyzed; (2) nitrogen at 180 mL/min continued to be used for purging for 5 minutes; (3) mixed gas (36 mL/min H₂O_{(g)}-324 mL/min N₂) of steam and nitrogen with total flow of 360 mL/min was introduced for 10 minutes, a volume of the steam was 10% of the total volume of the gas, tail gas within 20 minutes (steam oxidation stage for 10 minutes+nitrogen purging for 10 minutes) was collected by a gas bag, and a composition of the tail gas was analyzed by gas chromatography; (4) nitrogen at 324 mL/min continued to be used for purging for 5 minutes; (5) air at 360 mL/min was used for oxidation for 10 minutes; and (6) nitrogen at 180 mL/min was used for continuous purging for 10 minutes. Reaction activities of the oxygen carriers in the above embodiment are all an average activity of a corresponding reaction stage; a volume space velocity of the reaction is 900 h⁻¹ with benchmarking against a reactant, namely the methane, and the volume space velocity of the response is 900 h⁻¹ with benchmarking against the steam.

### Embodiment 13

1.5 mL of the La₃CoMnAlO₉ medium-entropy perovskite oxygen carrier prepared in Embodiment 5 was weighed and added to a monotube micro fluidized bed reactor with an internal diameter of a reaction tube of 20 mm, and an experiment was performed at 1100° C. and constant pressure. After temperature rose to 1100° C. in an N₂ atmosphere, (1) pure methane with total flow of 300 mL/min was introduced for 2 minutes, tail gas within 12 minutes (methane stage for 2 minutes+nitrogen purging for 10 minutes) was collected by a gas bag, and an average composition of the tail gas was analyzed; (2) nitrogen at 300 mL/min was used for purging for 5 minutes; (3) pure steam with flow of 300 mL/min was introduced for 3 minutes, tail gas within 13 minutes (steam stage for 3 minutes+nitrogen purging for 10 minutes) was collected by a gas bag, and a composition of the tail gas was analyzed by gas chromatography; (4) nitrogen at 300 mL/min was used for continuous purging for 5 minutes; (5) air at 300 mL/min was used for oxidation for 10 minutes; and (6) nitrogen at 300 mL/min was used for continuous purging for 5 minutes. Reaction activities of the oxygen carriers in the above embodiment are all an average activity of a corresponding reaction stage, a volume space velocity of the reaction is 12000 h⁻¹ with benchmarking against a reactant, namely the methane, and the volume space velocity of the reaction is 12000 h⁻¹ with benchmarking against the steam.

### Embodiment 14

2.4 mL of the La₃CoMnAlO₉ medium-entropy perovskite oxygen carrier prepared in Embodiment 5 was weighed and added to a monotube micro fluidized bed reactor with an internal diameter of a reaction tube of 20 mm, and an experiment was performed at 850° C. and constant pressure. After temperature rose to 850° C. in an N₂ atmosphere, (1) mixed gas (180 mL/min 20% CH₄/Ar-180 mL/min N₂) of methane and nitrogen with total flow of 360 m/min was introduced for 5 minutes, a volume of the methane was 10% of a total volume of the mixed gas, tail gas within 15 minutes (methane stage for 5 minutes+nitrogen purging for 10 minutes) was collected by a gas bag, and an average composition of the tail gas was analyzed; (2) nitrogen at 180 mL/min continued to be used for purging for 5 minutes; (3) mixed gas (36 mL/min H₂O_{(g)}-324 mL/min N₂) of steam and nitrogen with total flow of 360 mL/min was introduced for 10 minutes, a volume of the steam was 10% of the total volume of the gas, tail gas within 20 minutes (steam stage for 10 minutes+nitrogen purging for 10 minutes) was collected by a gas bag, and a composition of the tail gas was analyzed by gas chromatography; (4) nitrogen at 324 mL/min continued to be used for purging for 5 minutes; (5) air at 360 mL/min was used for oxidation for 10 minutes; and (6) nitrogen at 180 mL/min was used for continuous purging for 10 minutes. One complete cycle was completed by the above steps (1) to (6), and the test was performed for 50 consecutive cycles. Reaction activities of the oxygen carriers in the above embodiment are all an average activity of a corresponding reaction stage, a volume space velocity of the reaction is 900 h⁻¹ with benchmarking against a reactant, namely the methane, and the volume space velocity of the reaction is 900 h⁻¹ with benchmarking against the steam.

### Embodiment 15

2.4 mL of the La₃CoMnAlO₉ medium-entropy perovskite oxygen carrier prepared in Embodiment 5 was weighed and added to a fixed bed reactor with an internal diameter of a reaction tube of 20 mm, and an experiment was performed at 850° C. and constant pressure. After temperature rose to 850° C. in an N₂ atmosphere, (1) mixed gas (180 mL/min 20% CH₄/Ar-180 mL/min N₂) of methane and nitrogen with total flow of 360 mL/min was introduced for 5 minutes, a volume of the methane was 10% of a total volume of the mixed gas, tail gas within 15 minutes (methane stage for 5 minutes+nitrogen purging for 10 minutes) was collected by a gas bag, and an average composition of the tail gas was analyzed; (2) nitrogen at 180 mL/min continued to be used for purging for 5 minutes; (3) mixed gas (36 mL/min H₂O_{(g)}-324 mL/min N₂) of steam and nitrogen with total flow of 360 mL/min was introduced for 10 minutes, a volume of the steam was 10% of the total volume of the gas, tail gas within 20 minutes (steam stage for 10 minutes+nitrogen purging for 10 minutes) was collected by a gas bag, and a composition of the tail gas was analyzed by gas chromatography; (4) nitrogen at 324 mL/min continued to be used for purging for 5 minutes; (5) air at 360 mL/min was used for oxidation for 10 minutes; and (6) nitrogen at 180 mL/min was used for continuous purging for 10 minutes. Reaction activities of the oxygen carriers in the above embodiment are all an average activity of a corresponding reaction stage, a volume space velocity of the reaction is 900 h⁻¹ with benchmarking against a reactant, namely the methane, and the volume space velocity of the reaction is 900 h⁻¹ with benchmarking against the steam.

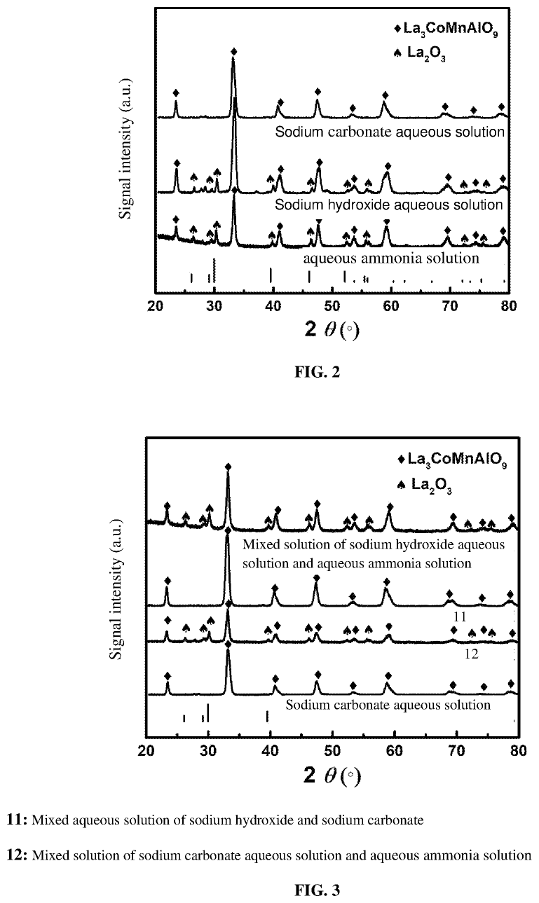

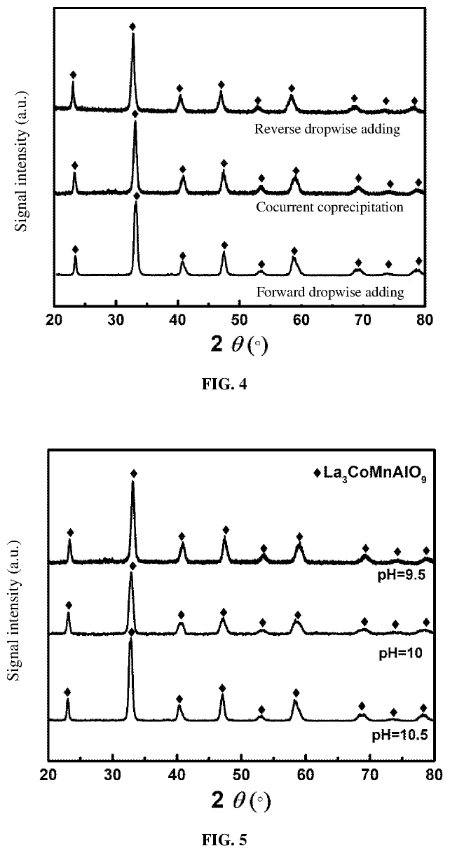

Results of the above embodiments were discussed as follows:
1. Influences of different precipitant types on preparation of La₃CoMnAlO₉ medium-entropy perovskite: the oxygen carriers were prepared by the methods in Embodiments 1, 2 and 3 respectively, an XRD test was performed, and please refer to FIG. 2 for XRD test results. It could be shown from FIG. 2 that the oxygen carriers containing medium-entropy perovskite structures could be prepared by adopting the aqueous ammonia solution, the sodium hydroxide aqueous solution or the sodium carbonate aqueous solution as the precipitant. Wherein, the effect was the best when the sodium carbonate aqueous solution was used as the precipitant, and no obvious impurity phases were detected.
2. Influences of use of one precipitant and use of two precipitants at the same time on preparation of the medium-entropy perovskite oxygen carriers: the La₃CoMnAlO₉ oxygen carriers were prepared by the methods in Embodiments 3, 4, 5 and 6 respectively, and an XRD test was performed, and please refer to FIG. 3 for XRD test results. It could be shown from FIG. 3 that when conditions such as final pH values of solutions and precipitant adding manners are controlled to be the same, the oxygen carriers containing medium-entropy perovskite structures could be prepared regardless of whether adopting one precipitant, namely the sodium carbonate aqueous solution (Embodiment 3), or adopting two precipitants (the mixed solution of the sodium hydroxide aqueous solution and the aqueous ammonia solution) (Embodiment 4), the mixed aqueous solution of sodium hydroxide and sodium carbonate) (Embodiment 5) or the mixed solution of the sodium carbonate aqueous solution and the aqueous ammonia solution (Embodiment 6)) at the same time. Wherein, the effect was the best when the mixed aqueous solution of the sodium hydroxide and the sodium carbonate (Embodiment 5) was adopted as the precipitants, and no impurity phases were detected.
3. Influences of change in the precipitant adding manners on preparation of the medium-entropy perovskite oxygen carriers: the La₃CoMnAlO₉ oxygen carriers were prepared by the methods in Embodiments 5, 7 and 8 respectively, and an XRD test was performed, and please refer to FIG. 4 for XRD test results. It could be shown from FIG. 4 that when conditions such as the final pH values of the solutions and the types of the precipitants were controlled to the same, the oxygen carriers containing medium-entropy perovskite structures could be prepared regardless of whether adopting a forward dropwise adding manner (Embodiment 5), a cocurrent coprecipitation manner (Embodiment 7), or a reverse dropwise adding manner (Embodiment 8), and no obvious impurity phases were detected.
4. Influences of change in the final pH values of the solutions on the medium-entropy perovskite oxygen carriers: the La₃CoMnAlO₉ oxygen carriers were prepared by the methods in Embodiments 5, 9 and 10 respectively, and an XRD test was performed, and please refer to FIG. 5 for XRD test results. It could be shown from FIG. 5 that when conditions such as the types of the precipitants and the adding manners were controlled to the same, the oxygen carriers containing medium-entropy perovskite structures could be prepared when the final pH values of the solutions range from 9.5 to 10.5, and no obvious impurity phases were detected.
5. Properties of the chemical-looping reforming reaction of methane to hydrogen of the La₃CoMnAlO₉ medium-entropy perovskite oxygen carriers at different reaction temperatures and space velocities: the oxygen carriers could keep high properties of the chemical-looping reforming reactions of methane and steam by reducing the space velocity or increasing the reaction temperature. Tests were performed by the methods in Embodiments 11, 12 and 13, and methane conversion rates and hydrogen purity were shown in Table 1. La₃CoMnAlO₉ showed the high methane conversion rate and syngas yield at the methane reduction stage under different reaction conditions and showed the high hydrogen purity and hydrogen yield at the steam re-oxidation stage, indicating that the oxygen carriers had excellent properties of the chemical-looping reforming reactions of methane and steam.

Table 1 Properties of chemical-looping reforming reaction of methane to hydrogen of La₃CoMnAlO₉ medium-entropy perovskite oxygen carriers at different reaction temperatures and space velocities

TABLE 1
Properties of chemical-looping reforming reaction of methane to hydrogen of
La₃CoMnAlO₉ medium-entropy perovskite oxygen carriers at different reaction temperatures and
space velocities

| | | Embodiment 12 | Embodiment 11 | Embodiment 13 |
|---|---|---|---|---|
| Reaction temperature (° C.) | | 850 | 700 | 1100 |
| Volume space velocity (h⁻¹) | | 900 | 120 | 12000 |
| Methane | Feed gas methane volume percentage | 10 | 5 | 100 |
| reduction | (%) | | | |
| stage | Methane conversion rate (%) | 83 | 65 | 90 |
| | Syngas (H₂ + CO) yield (mmol/mL_{catalyst}) | 5.75 | 0.62 | 18.35 |
| | Carbon dioxide selectivity (carbon | 41% | 90% | 30% |
| | dioxide capture rate) | | | |
| Steam re- | Steam volume percentage (%) | 10 | 5 | 100 |
| oxidation | Hydrogen purity (%) | 98.5 | 199.7 | 95.8 |
| stage | Hydrogen yield (mmol/mL_{catalyst}) | 3.75 | 0.36 | 6.51 |

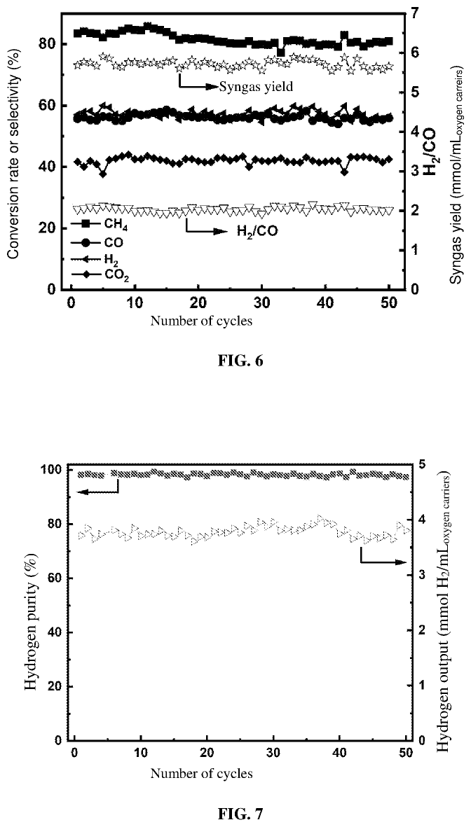

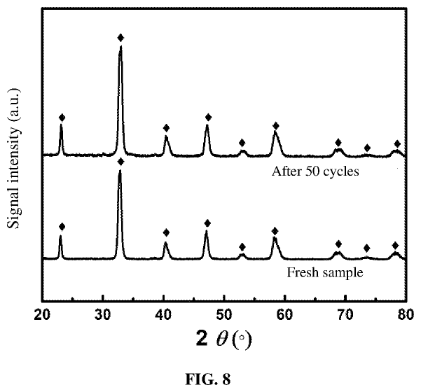

6. Long-period cycling stability of the La₃CoMnAlO₉ oxygen carrier: a test was performed by the method in Embodiment 14, and property test results of 50 consecutive cycles of the chemical-looping reforming reactions of methane and steam at the methane reduction stages and the steam re-oxidation stage were shown in FIG. 6 and FIG. 7. It could be shown from FIG. 6 that in 50 cycles of stability test processes, the La₃CoMnAlO₉ oxygen carrier showed high methane reaction properties and good stability at the methane reduction stage. The methane conversion rate was stabilized within 80% to 85%, and an Hz/CO ratio was stable and close to a theoretical value 2, indicating that the oxygen carrier had excellent reaction properties and cycling stability at the methane reduction stage. In addition, it could be shown from FIG. 7 that in the 50 cycles of stability test processes, the La₃CoMnAlO₉ oxygen carrier also showed high hydrogen purity and good cycling stability at the steam re-oxidation stage, and the hydrogen purity was stabilized within 97.5% to 99%. It could be shown that the oxygen carrier showed good cycling stability in the chemical-looping reforming reaction of methane to hydrogen.
7. In order to explore the structural stability of the oxygen carriers in several cycles of test processes, the fresh La₃CoMnAlO₉ oxygen carrier (Embodiment 5) and the oxygen carrier obtained after 50 cycles of the chemical-looping partial oxidation reactions of methane (Embodiment 14) was subjected to the XRD test. Results were shown in FIG. 8, XRD spectrograms of the La₃CoMnAlO₉ oxygen carriers obtained after 50 cycles were all medium-entropy perovskite feature diffraction peaks, and no impurity phases were detected, indicating that the oxygen carriers were still pure perovskite crystalline phases, which showed that the La₃CoMnAlO₉ medium-entropy perovskite oxygen carriers had excellent structural cycling stability.
8. In order to compare influences of two different types of the fluidized bed reactor and the fixed bed reactor on the properties of the chemical-looping reforming reaction of methane to hydrogen of the oxygen carriers, reaction properties of the La₃CoMnAlO₉ oxygen carrier were evaluated (Embodiment 15) by the fixed bed reactor under the conditions the same as those of the fluidized bed reactor (Embodiment 12), and result comparison was shown in Table 2. Compared with the fixed bed reactor, the oxygen carriers had the obviously higher hydrogen purity and hydrogen yield on the fluidized bed reactor. The reason is that when reactant gas (methane) is introduced into the reactor from one direction, reduction degrees of the oxygen carriers at different positions of a bed layer at the methane reduction stage are different when the fixed bed reactor is used (the oxygen carrier on an upper portion of the bed layer is prone to carbon deposition due to excessive reduction under high methane concentration, so that the hydrogen purity at the steam re-oxidation stage is reduced; while the oxygen carrier on a lower portion of the bed layer is slightly reduced due to high concentration of methane oxidized products, and a utilization rate of lattice oxygen is low, resulting in low yield of products on the oxygen carriers in unit mass). In comparison, when the fluidized bed reactor was used, the oxygen carriers were in a fluidized state, all the oxygen carriers uniformly made contact with the reactant gas (methane), the reduction degrees of the oxygen carriers were uniform, carbon deposits were less, the average reduction degree of the oxygen carriers could be properly increased, and the hydrogen yield was higher.

TABLE 2
Influences of different types of reactors on properties of chemical-looping reforming of
methane to hydrogen of La₃CoMnAlO₉ medium-entropy perovskite oxygen carriers

| | | Embodiment 12 | Embodiment 15 |
|---|---|---|---|
| | | (fluidized bed) | (fixed bed) |
| Reaction temperature (° C.) | | \|850 | 850 |
| Volume space velocity (h⁻¹) | | 900 | 900 |
| Methane | Feed gas methane volume percentage (%) | 10 | 10 |
| reduction stage | Methane conversion rate (%) | 83 | 90 |
| | Syngas (H₂ + CO) yield (mmol/mL_{catalyst}) | 5.75 | 3.24 |
| | Carbon dioxide selectivity (carbon dioxide | 41% | 38% |
| | capture rate) | | |
| Steam re- | Steam volume percentage (%) | 10 | 10 |
| oxidationstage | Hydrogen purity (%) | 98.5 | 92.7 |
| | Hydrogen yield (mmol/mL_{catalyst}) | 3.75 | 2.36 |

Although the preferred embodiments of the present disclosure are described above with reference to the drawings, the present disclosure is not limited to the above specific implementations, and the above specific implementations are only schematic instead of restrictive. Those ordinarily skilled in the art may also make many forms of specific transformations without departing from the purpose of the present disclosure and the scope protected by the claims under the inspiration of the present disclosure, and these transformations all belong to the protection scope of the present disclosure.

1. A preparation method of a medium-entropy perovskite oxygen carrier, including:
(1) preparing an aqueous solution from metallic nitrate serving as a raw material, and performing a coprecipitation reaction with at least one of aqueous ammonia solution, a sodium hydroxide aqueous solution or a sodium carbonate aqueous solution as a precipitant at a pH value of 9.5 to 10.5, to obtain a hydroxide precursor; and
(2) obtaining a La₃CoMnAlO₉ medium-entropy perovskite oxygen carrier after stirring, standing, washing, drying and calcining.

2. The preparation method according to claim 1, wherein the metallic nitrate is La(NO₃)₃·6H₂O, Co(NO₃)₃·6H₂O, a Mn(NO₃)₂ aqueous solution and Al(NO₃)₃·9H₂O; an ionic molar ratio of La to Co to Mn to Al is 3:1:1:1.

3. The preparation method according to claim 1, wherein, a mixing manner of the precipitant and the metallic nitrate solution is one of forward dropwise adding, cocurrent or reverse dropwise adding.

4. A medium-entropy perovskite oxygen carrier, wherein the medium-entropy perovskite oxygen carrier is prepared by claim 1.

5. Application of the medium-entropy perovskite oxygen carrier according to claim 4 in a reaction of chemical-looping reforming of methane to hydrogen in a fluidized bed, wherein at a reduction stage, the oxygen carrier reacts with the methane under an oxygen-free condition, the methane is partially oxidized by lattice oxygen in the oxygen carrier to generate syngas, and meanwhile the oxygen carrier is reduced; at the re-oxidation stage, the oxygen carrier reacts with steam, to obtain part of the lattice oxygen, and meanwhile hydrogen is generated; at an air combustion stage, the oxygen carrier is further oxidized by air to be cyclically regenerated, so that the oxygen carrier restores to a structure before reacting with the methane.

6. The application according to claim 5, wherein reaction temperatures of the reduction stage and the oxidation stage are 700° C. to 1100° C.

7. The application according to claim 5, wherein, mixed gas of methane and nitrogen is introduced at the reduction stage, wherein a volume percentage of the methane is 5% to 100%, and with benchmarking against methane, a volume space velocity of the reaction is controlled to be 120 h⁻¹ to 12000 h⁻¹.

8. The application according to claim 5, wherein mixed gas of steam and nitrogen is firstly introduced at the oxidation stage, wherein a volume percentage of the steam is 5% to 100%, and with benchmarking against steam, a volume space velocity of the reaction is controlled to be 120 h⁻¹ to 12000 h⁻¹.

9. The medium-entropy perovskite oxygen carrier of claim 4, wherein the metallic nitrate is La(NO₃)₃·6H₂O, Co(NO₃)₃·6H₂O, a Mn(NO₃)₂ aqueous solution and Al(NO₃)₃·9H₂O; an ionic molar ratio of La to Co to Mn to Al is 3:1:1:1.

10. The medium-entropy perovskite oxygen carrier of claim 4, wherein, a mixing manner of the precipitant and the metallic nitrate solution is one of forward dropwise adding, cocurrent or reverse dropwise adding.
